(19) United States
(12) Patent Application Publication
(10) Pub. No.: US 2013/0199136 A1
(43) Pub. Date: Aug. 8, 2013

(54) STABILIZING SYSTEM FOR A SADDLE

(71) Applicant: Dana WOODS, Dundas (CA)

(72) Inventor: Dana WOODS, Dundas (CA)

(21) Appl. No.: 13/570,345

(22) Filed: Aug. 9, 2012

Related U.S. Application Data
(63) Continuation-in-part of application No. 12/761,960, filed on Apr. 16, 2010, now Pat. No. 8,261,519.

(51) Int. Cl. B68C 1/02

(52) U.S. Cl. CPC B68C 1/02
USPC 54/44.1

(57) ABSTRACT

The invention also a stabilizing system to stabilize a rider in the saddle comprising a saddle stabilizer block which can be used alone or in combination with a complementary boot stabilizer block to restrict movement of the rider in the saddle.

### RELATED APPLICATIONS

This applications claims priority from U.S. Provisional Application No. 61/172,089 filed on Apr. 23, 2009 and is a continuation in part of U.S. patent application Ser. No. 12/761,960, the entireties of which is incorporated herein by reference.

### FIELD OF THE INVENTION

The invention relates generally to horseback riding saddles.

### BACKGROUND OF THE INVENTION

Horse saddles of the English riding type often have protrusions located on the saddle flaps called blocks. These blocks are typically placed either at the front edge of the saddle, the rear edge of the saddle or both the front and rear edges of the saddle. The blocks are either sewn to the leather of the saddle or are attached with Velcro. The purpose of traditional leg blocks is to prevent the rider's leg from moving too far forwards or too far backwards in the saddle.

Saddle blocks are able to be attached to the front and rear area of a saddle flap but are not able to be attached in the center area of the saddle flap because this is where the strap system that secures the saddle to the horse is located. In English saddles the securing strap is called a girth and circles around the midsection of the horse securing on both sides of the saddle by fixed straps called billets. Depending on the saddle type there can be one or multiple billet straps, these straps are confined to the central location of the saddle flap because the horse's shoulders and grooves behind the elbows are used to keep the saddle from sliding forward.

Traditional leg blocks will deform to a degree when the rider's leg is pressed against the block. Traditional blocks are attached to a leather saddle flap, when force is applied to the traditional leg block the flexible leather saddle flap will also deform. Traditional leather saddle flaps and traditional leg blocks are too pliable to create enough resistance to retard the upward momentum of the rider's leg that is created by the motion of the horse.

It is known that shoulder-hip-heel positioning with the shoulder-hip-heel line being located in the area of the girth is appropriate for multiple riding disciplines, however, this can be difficult to achieve without blocks to guide the rider's legs into the appropriate position.

Horse saddles typically have a weight distributing internal component referred to as a saddle tree. Traditionally, saddle trees are comprised of a relatively solid, usually wooden structure which is used to transfer the weight of the rider evenly over the horse's back.

Stirrups are affixed to the saddle tree by a stirrup bar which holds the stirrup strap. The stirrup bar allows the stirrup strap to become dislodged, preventing a fallen rider from being dragged behind the horse. The stirrup bar is not placed in the center of the saddle in the shoulder-hip-heel line and girth area because the stirrup bar will interfere with the rider's inner thigh. Also, the central area of the saddle is less reinforced and is more prone to damage from use; this is why traditionally the stirrup bar is affixed to the front portion of the saddle tree. Forward placement of the stirrup bar encourages sub-optimal rider posture. It is known that shoulder-hip-heel positioning is appropriate for multiple riding disciplines, however, this is difficult to achieve with a forward stirrup attachment.

Furthermore, riders typically experience instability in the saddle coincident with movement of the horse. Instability can be experienced on horses with bouncy or exuberant gaits, in jumping activities, during activities that involve high speeds or activities involving changes in the rate of speed. Improvements in saddles that provided riders with increased security in the saddle and diminished the negative impact of the rider's movements on the horse's back would be of great benefit.

### SUMMARY OF THE INVENTION

A saddle stabilizer block for stabilizing a rider in a saddle comprising an attachment means to attach the saddle stabilizer block to the saddle at a position to allow engagement of the saddle stabilizer block with the lower leg of a rider.

A stabilizing system for stabilizing a rider to a saddle comprising at least one saddle stabilizer block attachable to the saddle and a boot stabilizer block attachable to at least one of a boot and a lower leg of a rider, wherein the saddle stabilizer block and the boot stabilizer block engage to stabilize the rider in the saddle.

Preferably, the saddle stabilizer block is attached to the saddle at a location that contains the girth strap system that attaches the saddle to the horse.

### BRIEF DESCRIPTION OF THE DRAWINGS

These and other features of the preferred embodiments of the invention will become more apparent in the following detailed description in which reference is made to the appended drawings wherein:

FIG. 1A shows a side elevation view of a traditional English saddle.

FIG. 1B shows the saddle of FIG. 1A having a saddle flap raised.

FIG. 2 shows an exploded view of a saddle stabilizer block attached to a pair of girth billets according to another aspect of the saddle of the present invention.

FIG. 3A shows a perspective view of a boot stabilizer block for use with the saddle of the present invention directly attached to a boot.

FIG. 3B shows a perspective view of the boot stabilizer block attached to a strap having a buckle for adjustable attachment of the boot stabilizer block to a leg of a rider.

FIG. 3C shows a side elevation view of the boot stabilizer block with a clip for attachment to the boot of a rider.

FIG. 3D shows a side elevation view of the boot stabilizer block with an overhang for slidable engagement with the boot of a rider.

FIG. 4 shows a side elevation cross-sectional view of the saddle stabilizer block attached to the saddle engaged with the boot stabilizer block attached to the boot of a rider.

FIG. 5 shows a perspective view of an alternative embodiment of the saddle stabilizer block attached to girth billets and the boot stabilizer block attached to the boot of a rider.

FIG. 6 shows a side elevation view of another alternative embodiment of the saddle stabilizer block attached to girth billets and the boot stabilizer block attached to the boot of a rider.

FIG. 7 shows a side elevation view of a saddle stabilizer block attached to a pair of widened girth billets.

FIG. 8 shows a perspective view of the saddle stabilizer block attached to a separate set of straps.

FIG. 9 shows a perspective view of the saddle stabilizer block attached to a girth plate.

FIG. 10 shows a side elevation cross-sectional view of the saddle stabilizer block attached to the saddle and engaged with the knee of a rider.

FIG. 11 shows a side elevation view, from behind the knee of a rider, of the saddle stabilizer block attached to the saddle and engaged with the knee of a rider.

FIGS. 12A-12C show perspective views of alternate embodiments of the saddle stabilizer block.

FIG. 13 shows the saddle stabilizer block of FIG. 12A positioned to interact with the small of the knee of the rider.

FIG. 14 shows a saddle with the saddle stabilizer block underneath the outer saddle flap in a first position.

FIG. 15 shows a saddle with the saddle stabilizer block underneath the outer saddle flap in a second position.

### DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and/or processes have not been described or shown in detail in order not to obscure the invention. In the description and drawings, like numerals refer to like structures or and/or processes.

It must be noted that as used herein and in the appended claims, the singular forms “a”, “an” and “the” include the plural referents unless the context clearly dictates otherwise.

Thus, for example, reference to “a saddle stabilizer block” includes reference to one or more devices and equivalents thereof known to those skilled in the art, and so forth.

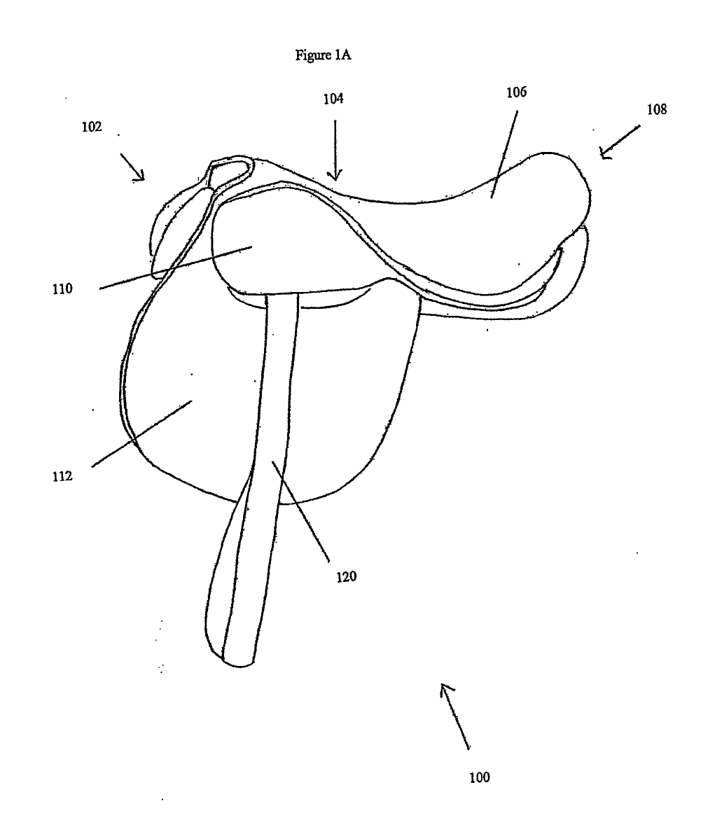

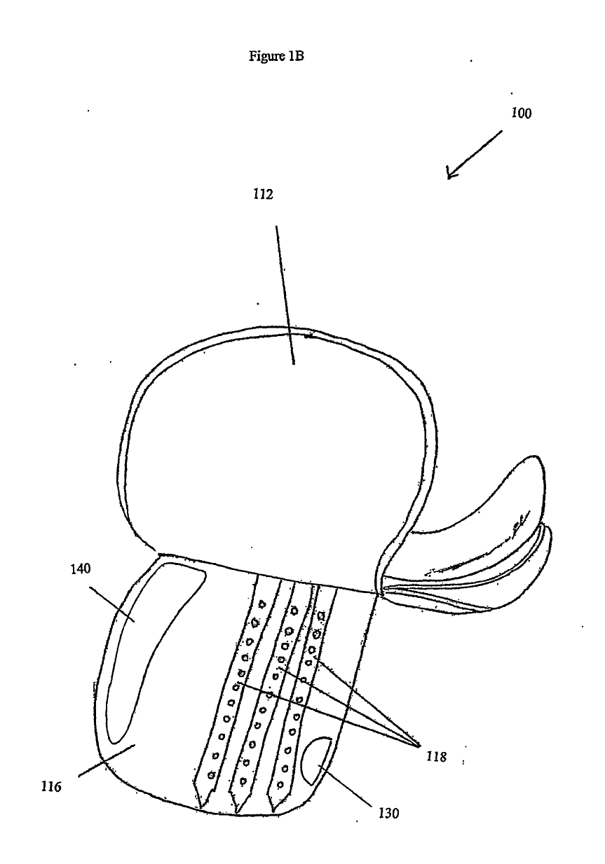

FIG. 1A illustrates a traditional English saddle 100, the saddle 100 having a saddle pommel region 102 at a front portion of the saddle 100, a saddle twist region 104 at the most narrow part of the saddle 100 directly behind the saddle pommel region 102, a saddle seat region 106 to accommodate a rider and a saddle cantle region 108 at a rear portion of the saddle 100. A stirrup bar (not shown) is attached to a saddle tree (not shown) and extends from a saddle skirt 110 which covers the saddle tree (not shown). An outer saddle flap 112 is shown extending from underneath the saddle skirt 110. A stirrup leather 120 is shown extending from underneath the saddle skirt 110. The stirrup leather 120 is attached to the saddle 100 by means of the stirrup bar (not visible).

FIG. 1B is a side elevation view of the saddle 100 with the outer flap 112 raised exposing the underlying lower flap (or sweat flap) 116 and girth billets 118 which are attached to the saddle tree (not shown). A traditional front leg block 140 and rear leg block 130 are shown.

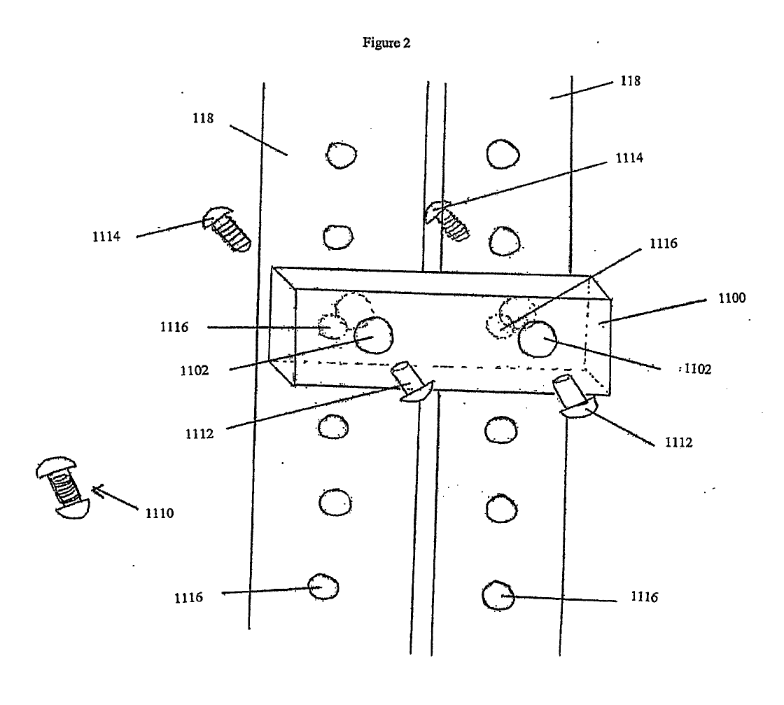

According to an aspect of the invention, a stabilizing system is provided for stabilizing a rider in a saddle. Referring to FIG. 2, a saddle stabilizer block 1100 attached to a pair of girth billets 118 is shown in exploded view. The saddle stabilizer block 1100 has apertures 1102 that extend through the saddle stabilizer block 1100. A Chicago screw 1110 shown in cross section is used to attach the saddle stabilizer block 1100 to the girth billet 118. A female end 1112 of the Chicago screw 1110 is inserted through an aperture 1102 in the saddle stabilizer block 1100. A male end 1114 of the Chicago screw 1110 is inserted through an aperture 1116 in the girth billet 118. In order to secure the saddle stabilizer block 1100 to the girth billet 118, the male end 1114 of the Chicago screw 1110 is securely inserted into the female end 1112 of the Chicago screw 1110. Preferably, the saddle stabilizer block 1100 attaches to at least one aperture 1116 on each the girth billets 118. More preferably, the saddle stabilizer block 1100 has multiple apertures 1102 to enable attachment of the saddle stabilizer block 1100 to each girth billet 118 at multiple points. The above describes an internal version of the saddle stabilizer block 1100 as it is attached directly to the girth billets 118 which are generally located beneath a saddle flap 112. The saddle stabilizer block 1100 is positioned to engage a rider's lower leg, stabilizing the rider in the saddle 100. The saddle stabilizer block 1100 is attached to the girth billets 118 of the saddle 100 by means of weight-bearing fasteners such as Chicago screws 1110. Preferably, the saddle stabilizer block 1100 engages a rider's leg just below the knee.

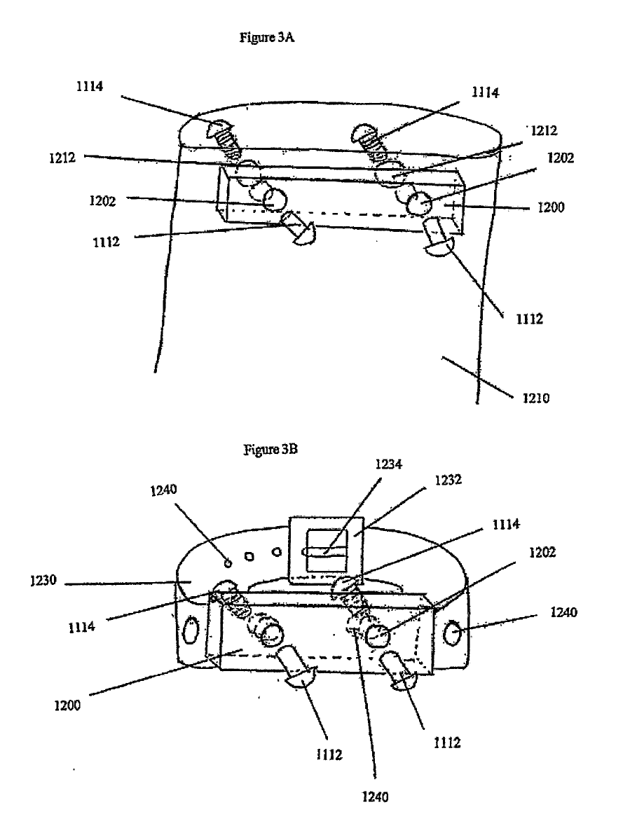

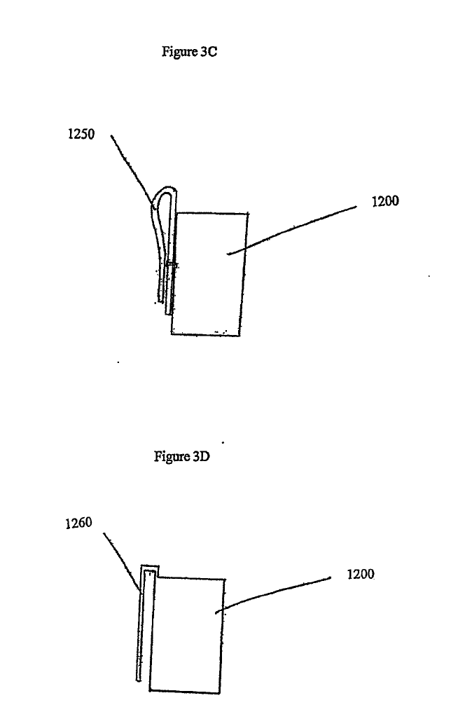

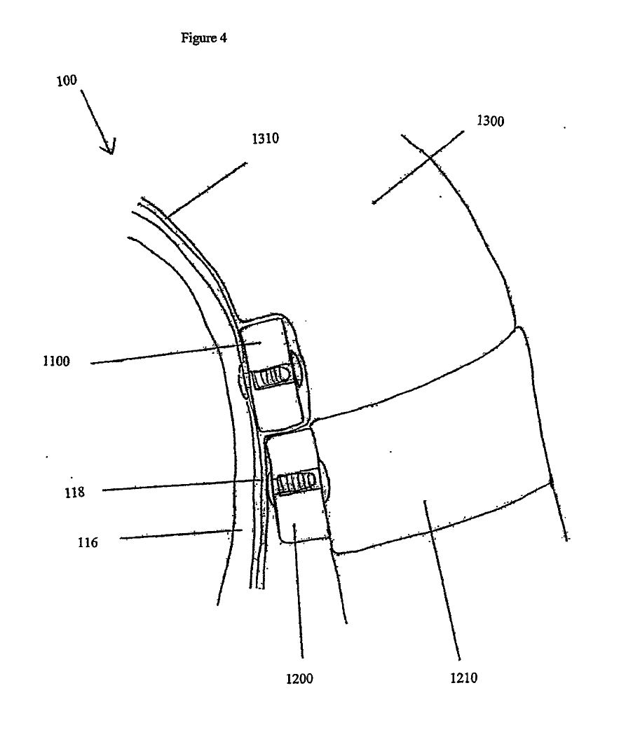

Although the saddle stabilizer block 1100 may engage a rider's lower leg or a boot 1210 directly, preferably, the stabilizing system includes a corresponding boot stabilizer block. Referring to FIG. 3A, a boot stabilizer block 1200 attached to the boot 1210 is shown in exploded view. A boot stabilizer block aperture 1202 extends through the boot stabilizer block 1200. The female end 1112 of the Chicago screw 1110 is inserted through the boot stabilizer block aperture 1202. The male end 1114 of the Chicago screw 1110 is inserted through a boot aperture 1212. The male end 1114 of the Chicago screw 1110 is securely inserted into the female end 1112 of the Chicago screw to secure the boot stabilizer block 1200 to the boot 1210. Preferably, the boot stabilizer block 1200 attaches to the boot 1210 at least at two points. It would be obvious to a person of skill in the art that more than two points of attachment are possible providing more secure attachment of the boot stabilizer block 1200.

Referring to FIG. 3B, the boot stabilizer block 1200 is attached to a leg strap 1230 having a buckle 1232 for adjustable attachment of the leg strap 1230 to a leg of a rider shown in exploded view. The leg strap 1230 is adjustable where a buckle prong 1234 is insertable into any leg strap aperture 1240. The boot stabilizer block 1200 is attached to the leg strap 1230 by means of the Chicago screw 1110. The female end 1112 of the Chicago screw 1110 is inserted through the boot stabilizer block aperture 1202. The male end 1114 of the Chicago screw 1110 is inserted through the leg strap aperture 1240, securing the boot stabilizer block 1200 to the leg strap 1230. The leg strap 1230 can then be securely attached to the leg of a rider. Preferably, the boot stabilizer block 1200 attaches to the leg strap 1230 at least at two points. It would be obvious to a person of skill in the art that more than two points of attachment are possible.

The invention also provides for alternative ways to secure the boot stabilizer block 1200 to a rider. Referring to FIG. 3C, a side elevation view of the boot stabilizer block 1200 is shown where the boot stabilizer block 1200 is attached to a clip 1250 which engages the boot 1210 of a rider. FIG. 3D is a side elevation view of the boot stabilizer block 1200 having an overhang 1260 which enables sliding engagement with the boot 1210 of a rider.

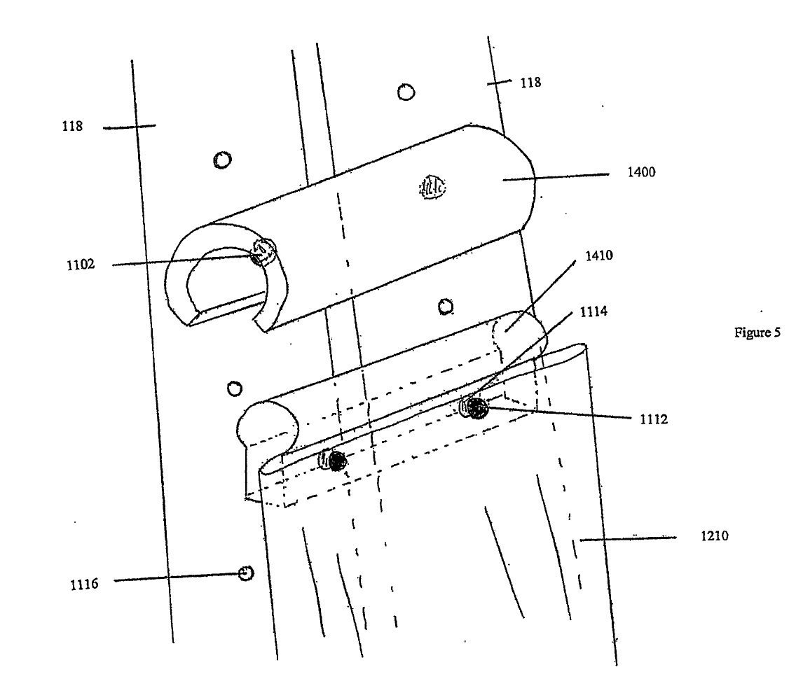

Referring to FIG. 4, a cross section of the saddle stabilizer block 1100 attached to the saddle 100 is shown in front elevation view. The saddle stabilizer block 1100 is engaged with the boot stabilizer block 1200 which is itself attached to the boot 1210 of a rider, a portion of whose leg 1300 is visible. The boot stabilizer block 1200 is directly attached to the boot 1210. The visible parts of the saddle 100 are the lower saddle flap 116, the girth billet 118, and a thin, flexible outer saddle flap 1310 facilitating engagement of the saddle stabilizer block 1100 with the boot stabilizer block 1200. When the rider is mounted in the saddle 100, the saddle stabilizer block 1100 engages the boot stabilizer block 1200 such that movement of the rider out of the saddle is restricted. Referring to FIG. 5, an alternative saddle stabilizer block 1400 is shown in perspective view that is substantially C-shaped in cross-section. An alternative boot stabilizer block 1410 has a substantially cylindrical component to enable engagement of the alternative boot stabilizer block 1410 with the alternative saddle stabilizer block 1400.

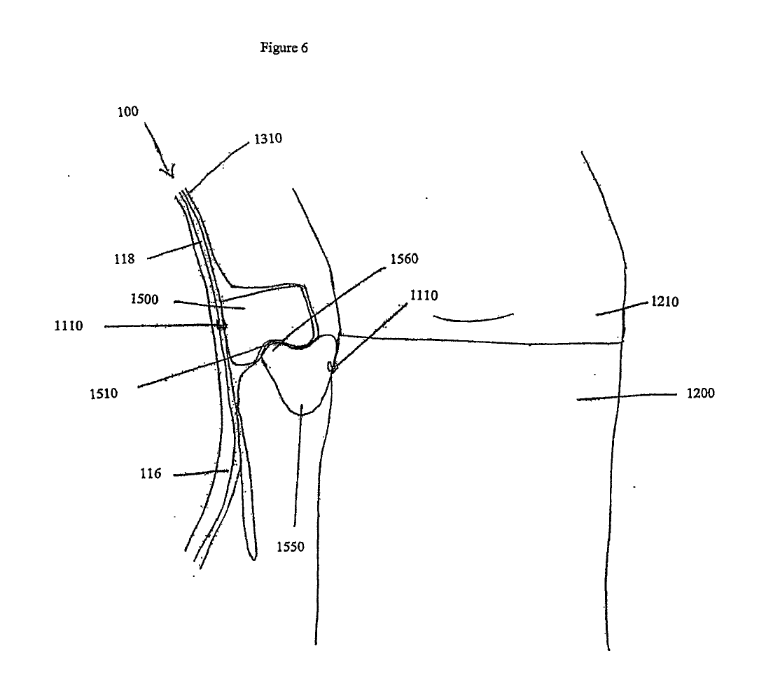

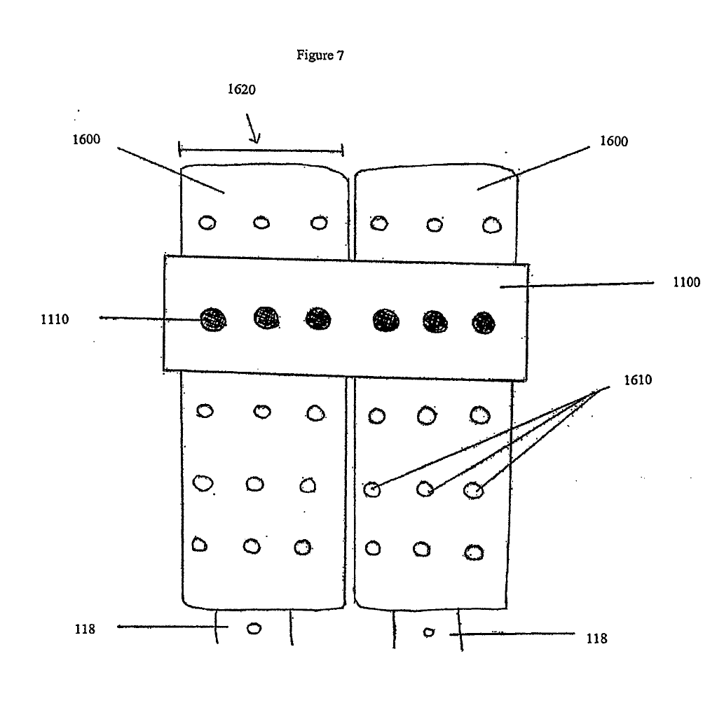

Referring to FIG. 6, an alternative saddle stabilizer block 1500 is shown in side elevation view that has an indentation 1510 along the length of one side of the alternative saddle stabilizer block 1500 to accommodate an alternative boot stabilizer block 1550 that is substantially V-shaped. A terminal end 1560 of the V-shaped boot stabilizer block 1550 is complementary in shape to the indentation 1510 of the saddle stabilizer block. The alternative saddle stabilizer block 1500 can be attached to the saddle 100 via the girth billets 118 and the alternative boot stabilizer block 1550 can be attached to the boot 1200 or lower leg 1210 of a rider as described previously.

Referring to FIG. 7, a widened girth billet 1600 attached to the girth billet 118 is shown in side elevation view. The widened girth billet 1600 has multiple apertures 1610 across the width 1620 of the widened girth billet 1600 to enable secure attachment of the saddle stabilizer block 1100 at multiple points on the widened girth billet 1620 by means of Chicago screws 1110. It would understood by a person of skill in the art that such multipoint attachment of the saddle stabilizer block 1100 to the widened girth billet 1600 provides more secure attachment of the saddle stabilizer block 1100 to the saddle 100 than is provided by standard girth billets 118.

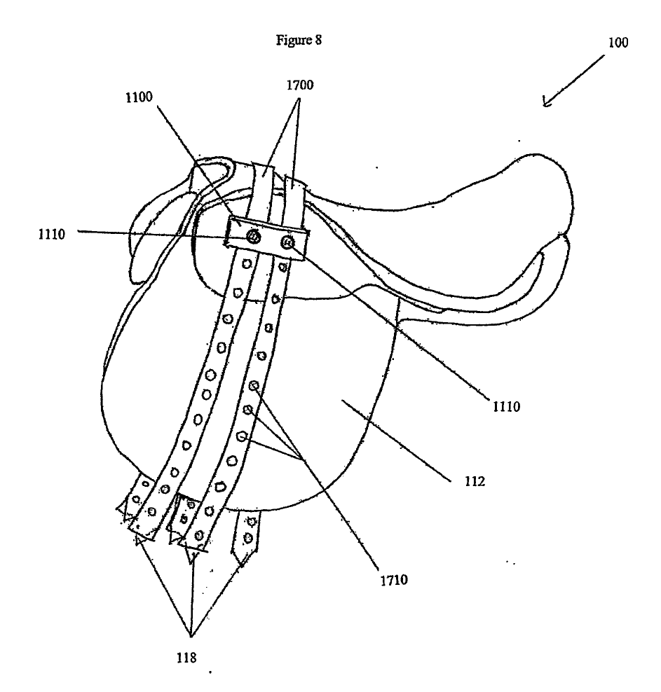

Referring to FIG. 8, the saddle stabilizer block 1100 is shown in perspective view attached to a pair of straps 1700 by means of Chicago screws 1110. The pair of straps 1700 is attached to the saddle 100 externally. By externally is meant that the pair of straps 1700 sit on top of the saddle 100. Multiple apertures 1710 along the length of the pair of straps 1700 enable adjustable attachment of the saddle stabilizer block 1100. The pair of straps 1700 having an attached saddle stabilizer block 1100 can be placed over the top of a saddle 100 and secured to the saddle 100 by means of Chicago screws 1110 that attach the pair of straps 1700 to the girth billets 118. The external version of the saddle stabilizer block 1100 has the advantage that it can be used with any saddle where the rider requires more security in the saddle 100 and more restricted movement when riding. In addition, as the saddle stabilizer block 1100 sits outside of the outer saddle flap 112, the saddle stabilizer block 1100 can more stably engage the boot stabilizer block 1200 providing the rider with more security in the saddle 100 when riding.

While Chicago screws 1110 have been described for the current invention, it would be understood by a person of skill in the art that other fasteners could be substituted to achieve the same function in any case where a Chicago screw 1110 is used.

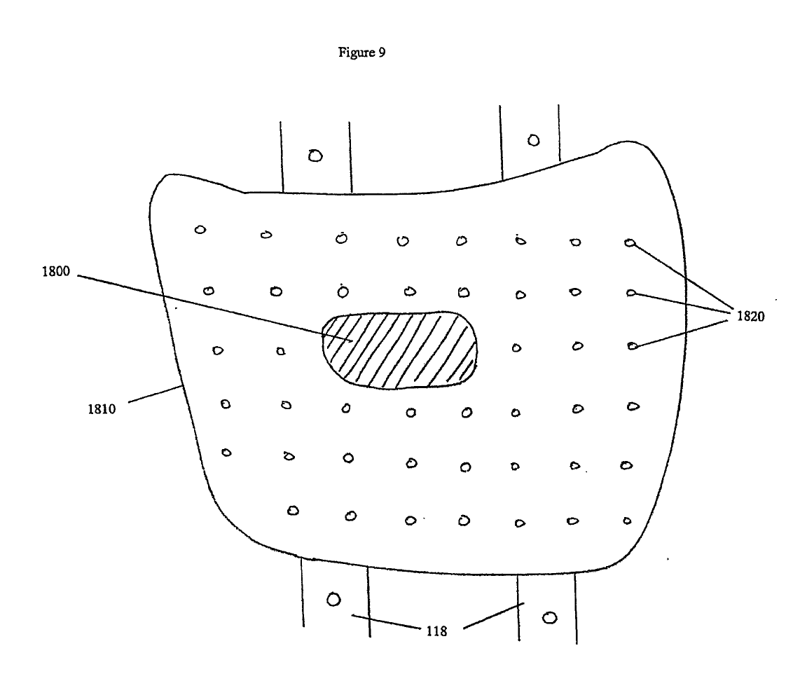

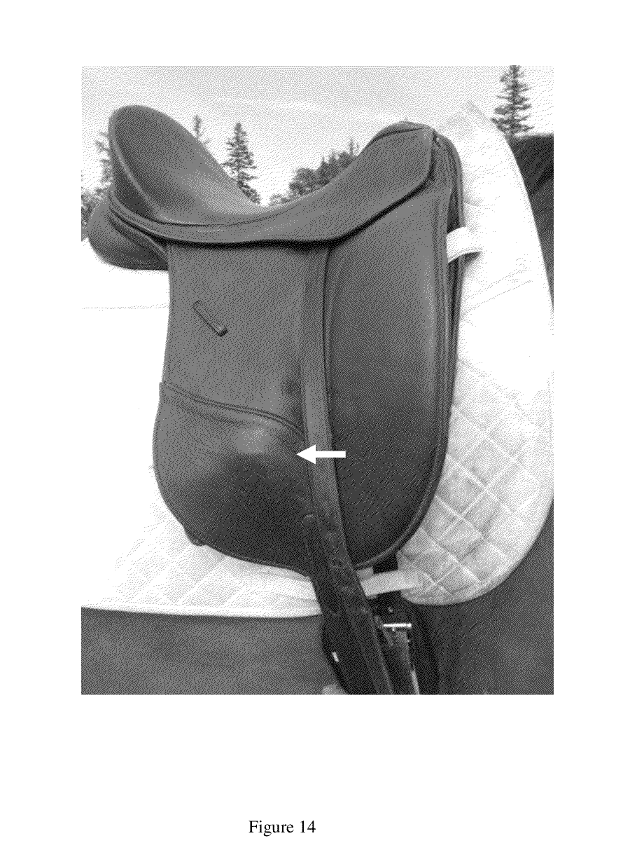

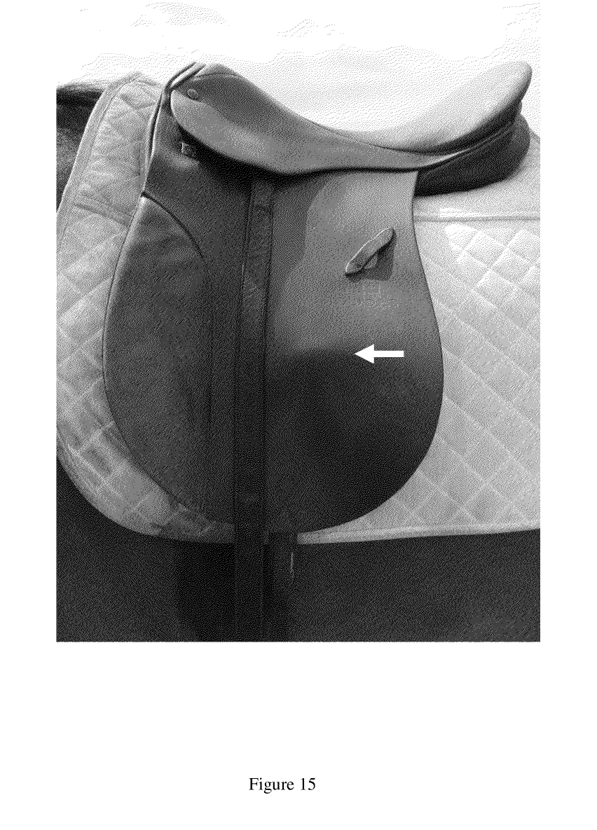

Referring to FIG. 9, another embodiment is shown. Saddle stabilizer block 1800 is attached to girth plate 1810. Girth plate 1810 is attachable to the saddle, preferably via girth billets 118 and/or the lower flap 116. If the girth plate 1810 is attached to the lower flap 116 of the saddle, then lower flap 116 is preferably also coupled to girth plate 1810 to provide further stability to the stabilizing system. In this embodiment, saddle stabilizer block 1800 is rounded for comfort. The girth plate 1810 is preferably made of plastic and contains a plurality of attachment points 1820. Advantageously, this embodiment allows the saddle stabilizer block 1800 to be attached at multiple and alternate positions on the saddle by attachment to different attachment points 1820. There are numerous manners in which the saddle stabilizer block 1800 can be attached to the girth plate 1810. For example, each of the attachment points 1820 can be a bore to receive a Chicago screw. Alternatively, the attachment points 1820 can be male/female fitted to a corresponding attachment point on the saddle stabilizer block 1800. This embodiment also permits the easy attachment of multiple saddle stabilizer blocks 1800. FIGS. 14 and 15 show the stabilizer block 1800 attached approximately near the center of the saddle with alternate positioning customized for different riders' leg length and leg positioning.

In embodiments of the stabilizer block described, the stabilizer block is preferably coupled to the saddle in order to bear the weight of the rider. This is distinguished from other foam blocks of the art which are typically attached to the saddle by sewing or Velcro™. Further, the stabilizer block is preferably made of a material sufficiently hard and/or rigid to bear the weight of the rider and withstand use over time. In a specific embodiment, the stabilizer block is made of plastic or thermoplastic and optionally reinforced with metal.

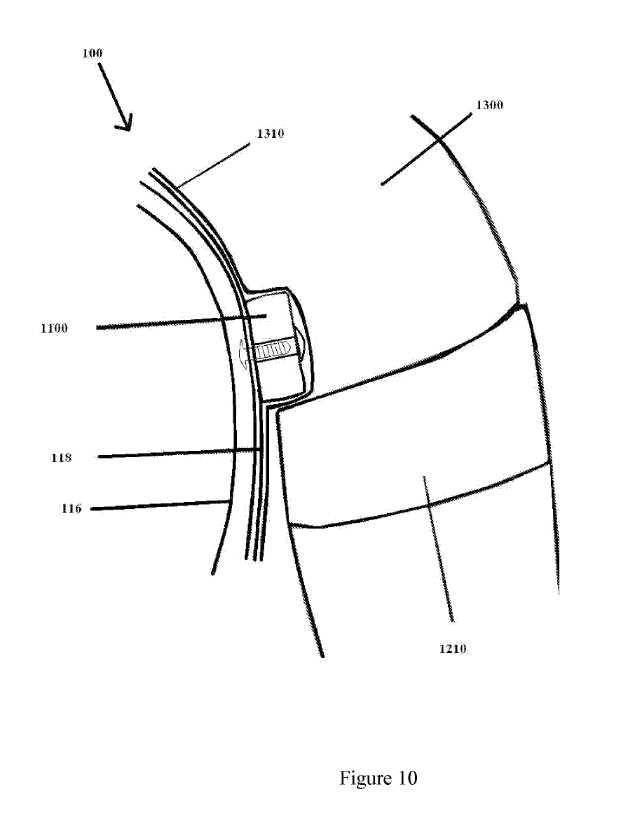

Referring to FIG. 10, a preferred embodiment is shown where the saddle stabilizer block 1100 directly engages the knee of a rider (without corresponding boot stabilizer block 1200). The visible parts of the saddle are the lower saddle flap 116, the girth billet 118, and a thin, flexible outer saddle flap 1310. Though not shown, it is preferable that girth plate 1810 is also used in order provide additional structural support and to allow custom positioning of the saddle stabilizer block 1100. When the rider is mounted in the saddle, the saddle stabilizer block 1100 engages the knee of the rider such that movement of the rider out of the saddle is restricted. The saddle stabilizer block 1100 is preferably positioned behind the knee of the rider to engage the small of the knee. In this position, the rider is able to cup the saddle stabilizer block 1100 when the rider's knee is bent, thus stabilizing the rider. This is of great benefit to both the rider and the horse. In the case of the rider, restricted upward movement results in maintenance of physical communication with the horse, ultimately resulting in the horse being more responsive to the rider. With respect to the horse, the restricted movement of the rider minimizes the force exerted on the back of the horse due to impact of the rider, for example upon completion of a jump.

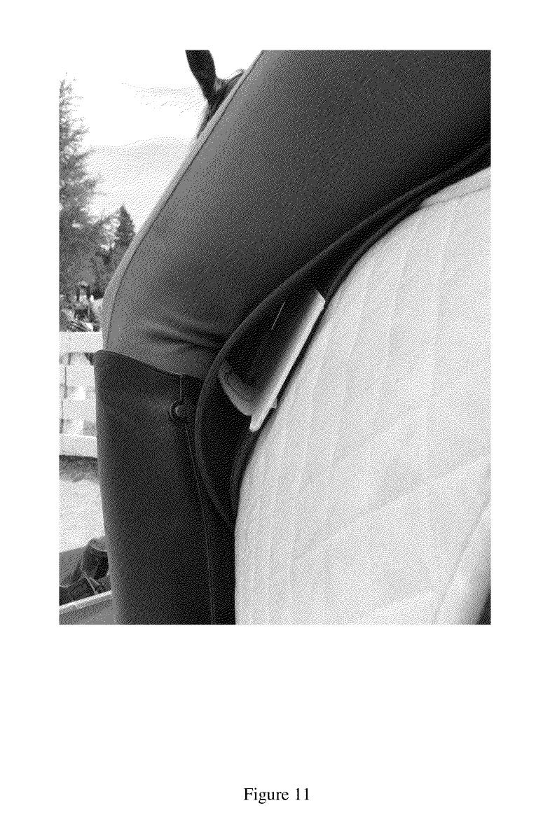

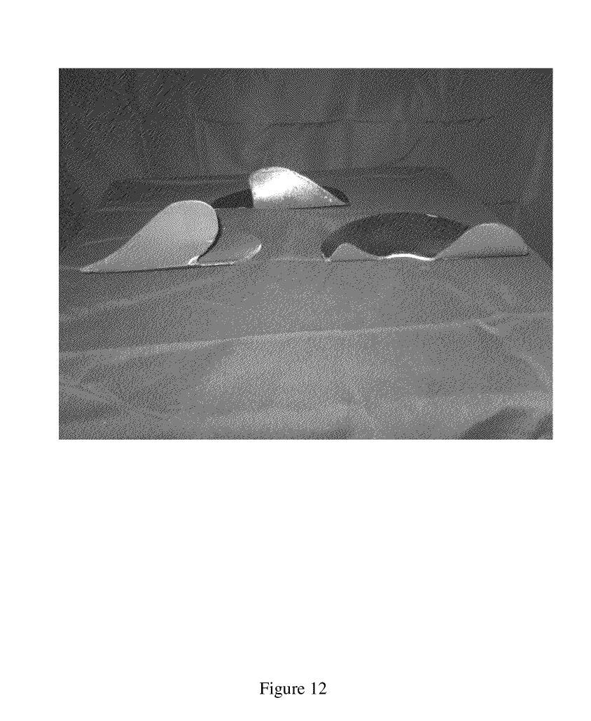

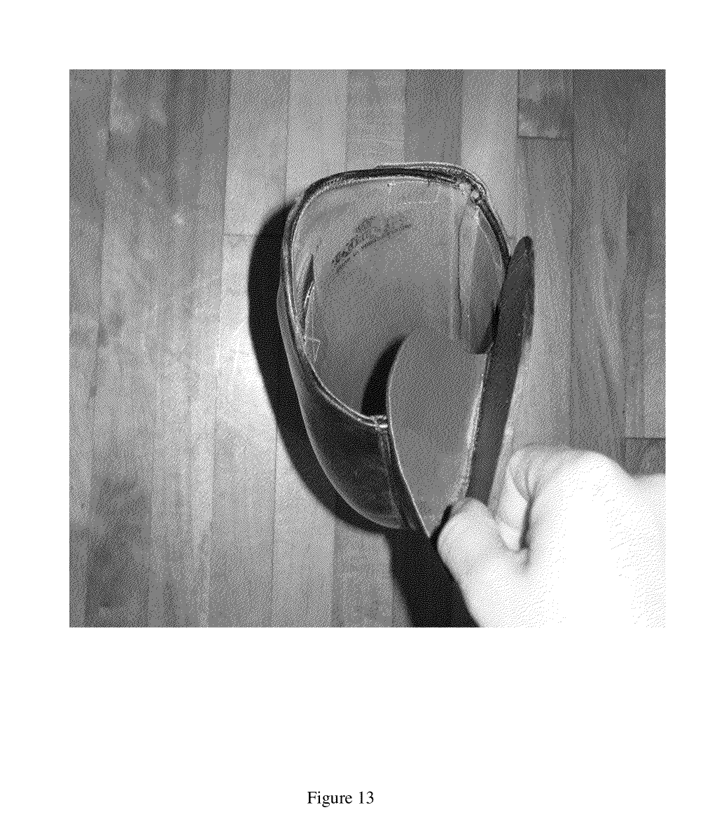

FIGS. 12A-12C show alternate embodiments of the stabilizer block 2100, 2200, 2300. Each of stabilizer blocks 2100, 2200, 2300 are formed as brackets, comprising a vertical plate, for attachment to the saddle (preferably via girth plate 1810), with a lip for engagement with the leg of the rider. FIGS. 11 and 13 show stabilizer block 2100 positioned to engage the small of the knee of the rider. As can be seen in FIG. 11, stabilizer block 2100 is attached to girth plate 1810. The lip of stabilizer block 2100 engages the small of the knee of the rider through outer saddle flap 112 by forming a protrusion thereon. The corresponding protrusions are also shown in FIGS. 14 and 15.

Although preferred embodiments of the invention have been described herein, it will be understood by those skilled in the art that variations may be made thereto without departing from the spirit of the invention or the scope of the appended claims.

1. A saddle stabilizing system for stabilizing a rider to the saddle comprising a saddle stabilizer block and an attachment to attach the block to the saddle at a position for engagement with the leg of a rider.

2. The saddle stabilizing system of claim 1, wherein the attachment is a weight-bearing fastener to attach the saddle stabilizer block to a girth billet of the saddle.

3. The saddle stabilizing system of claim 1, wherein the attachment is a weight-bearing fastener to attach the saddle stabilizer block to a lower flap of the saddle.

4. The saddle stabilizing system of claim 1, wherein the saddle stabilizer block is for engagement with the lower leg of the rider just below the knee.

5. The saddle stabilizing system of claim 1, wherein the saddle stabilizer block is for engagement with the lower leg of the rider at the small of the knee.

6. The saddle stabilizing system of claim 1, wherein the saddle stabilizer block is formed from a material of sufficient hardness to bear the weight of the rider.

7. The saddle stabilizing system of claim 6, wherein the saddle stabilizer block is formed from plastic or thermoplastic.

8. The saddle stabilizing system of claim 7, wherein the saddle stabilizer block is reinforced with metal.

9. The stabilizing system of claim 1, further comprising a girth plate for attachment to a side of the saddle and wherein the stabilizer block is attached to the girth plate.

10. The stabilizing system of claim 9, wherein the girth plate is formed from plastic or thermoplastic.

11. The stabilizing system of claim 9, wherein the girth plate contains multiple points of attachment for the saddle stabilizer block, allowing attachment of the saddle stabilizer block at alternate positions on the side of the saddle.

12. The stabilizing system of claim 9, wherein the girth plate is attachable to a girth billet or a lower flap of the saddle.

13. The stabilizing system of claim 6, wherein the stabilizing block comprises a vertical plate for attachment to the saddle and a lip for engagement with the leg of the rider.

14. The stabilizing system of claim 11, wherein the stabilizing block comprises a vertical plate for attachment to the girth plate and a lip for engagement with the leg of the rider.

15. A saddle comprising the stabilizing system of claim 1.

16. The saddle of claim 15, wherein the stabilizing system further comprising a girth plate attached to a side of the saddle and wherein the stabilizer block is attached to the girth plate.

17. The saddle of claim 16, wherein the girth plate contains multiple points of attachment for the saddle stabilizer block allowing attachment of the saddle stabilizer block at alternate positions on the side of the saddle.

18. The saddle of claim 17, wherein the saddle stabilizer block is positioned to engage the leg of the rider at the small of the knee.

19. The saddle of claim 18, wherein the stabilizing block comprises a vertical plate for attachment to the girth plate and a lip for engagement with the leg of the rider.
